(19) United States
(12) Patent Application Publication
(10) Pub. No.: US 2025/0120349 A1
(43) Pub. Date: Apr. 17, 2025

(54) WORKING MACHINE

(71) Applicant: MAKITA CORPORATION, Anjo-shi (JP)

(72) Inventor: Shunsuke MURAKAWA, Anjo-shi (JP)

(73) Assignee: MAKITA CORPORATION, Anjo-shi (JP)

(21) Appl. No.: 18/906,258

(22) Filed: Oct. 4, 2024

(30) Foreign Application Priority Data
Oct. 11, 2023 (JP) 2023-176310

(51) Int. Cl. A01G 20/47

(52) U.S. Cl. CPC A01G 20/47

(57) ABSTRACT

A working machine may include: a gripping member configured to be gripped by a user with one hand; a protection member that covers a surface of the gripping member at least partially and is constituted of a conductive material; an operation member configured to be operated by the user with the one hand; a detection sensor configured to detect an operation on the operation member; and a control unit. The protection member may include a contact portion received inside the gripping member. The detection sensor may include: a conductive component electrically connected to the control unit; and a sensor case that holds the conductive component and is constituted of an insulating material. The contact portion may be in contact with the sensor case.

### REFERENCE TO RELATED APPLICATIONS

This application claims priority from Japanese Patent Application No. 2023-176310 filed on Oct. 11, 2023. The entire content of the priority application is incorporated herein by reference.

### TECHNICAL FIELD

The art disclosed herein relates to a working machine.

### BACKGROUND ART

A working machine described in Chinese Patent No. 106284150 includes: a gripping member configured to be gripped by a user with one hand; a protection member that covers a surface of the gripping member at least partially and is constituted of a conductive material; an operation member configured to be operated by the user with the one hand; a detection sensor configured to detect an operation on the operation member; an air flow passage; an air flow fan disposed in the air flow passage; an electric motor configured to rotate the air flow fan; a conductive ring surrounding an outer surface of the air flow passage; and a control unit configured to control an operation of the electric motor. The detection sensor includes a conductive component electrically connected to the control unit and a sensor case that holds the conductive component and is constituted of an insulating material. The protection member is electrically connected with the control unit and the conductive ring. In this working machine, the protection member constituted of the conductive material is in contact with the user's hand, and also the protection member is electrically connected with the control unit and the conductive ring. Thus, when static electricity is generated during use of the working machine, electric charge moves promptly to the user's hand through the protection member. According to such configuration, electric discharge on the user's hand due to accumulation of static electricity in the working machine can be suppressed from taking place. Further, in the above-described working machine, the conductive ring can be utilized to collect static electricity generated in the air flow passage.

### SUMMARY

Normally, a control unit of a working machine is electrically connected to a power source that supplies power to the working machine. If the protection member is constituted of a conductive material and also the protection member is electrically connected to the control unit as in the working machine described in Chinese Patent No. 106284150, the power source which powers the working machine and the user's hand may be electrically connected, by which an electrification may happen. The present disclosure provides an art configured to suppress a user's hand from becoming electrically connected to a control unit, and suppress electric discharge caused by static electricity from taking place on a user's hand.

Further, in the working machine of Chinese Patent No. 106284150, the conductive ring is utilized for collecting the static electricity generated in the air flow passage. The present disclosure provides an art configured to collect static electricity generated in an air flow passage with a simpler configuration.

A working machine disclosed herein may comprise: a gripping member configured to be gripped by a user with one hand; a protection member that covers a surface of the gripping member at least partially and is constituted of a conductive material; an operation member configured to be operated by the user with the one hand; a detection sensor configured to detect an operation on the operation member; and a control unit. The protection member may include a contact portion received inside the gripping member. The detection sensor may include: a conductive component electrically connected to the control unit; and a sensor case that holds the conductive component and is constituted of an insulating material, and the contact portion may be in contact with the sensor case.

According to the above configuration, because the protection member is constituted of the conductive material and the contact portion is in contact with the sensor case, when static electricity is accumulated in the working machine, electric discharge will happen between the conductive component of the detection sensor and the contact portion of the protection member, and electric charge will be transferred from the protection member to the user's hand. Due to this, the user's hand is not electrically connected to the control unit, and further, electric discharge caused by static electricity can be suppressed from taking place on the user's hand. According to the above configuration, since the contact portion is in contact with the sensor case, variation in a distance between the contact portion and the conductive member can be suppressed from being generated, and stable electric discharge property can be realized between the contact portion and the conductive member.

Another working machine disclosed herein may comprise: a gripping member configured to be gripped by a user with one hand; a protection member that covers a surface of the gripping member at least partially and is constituted of a conductive material; an air flow passage; an air flow fan disposed in the air flow passage; an electric motor configured to rotate the air flow fan; and a wiring that is connected to the electric motor and extends 90 degrees or more in a circumferential direction along an outer surface of the air flow passage. Static electricity generated in the air flow passage may be collected by the wiring and transferred from the protection member to the one hand of the user.

According to the above configuration, without use of a special member such as a conductive ring, the wiring connected to the electric motor can be utilized to collect the electric charge of the static electricity generated in the air flow passage. Here, in this configuration, the wiring extending in the circumferential direction along the outer surface of the air flow passage and the protection member may be electrically connected, and/or insulation section(s) may be arranged between the wiring extending in the circumferential direction along the outer surface of the air flow passage and the protection member such that electric discharge may take place at these insulation section(s).

### BRIEF DESCRIPTION OF DRAWINGS

FIG. 1 illustrates an outer appearance of an entirety of a blower 10 according to an embodiment.

FIG. 2 illustrates a perspective view of a blower unit 16 according to the embodiment as seen from a front left upper side.

FIG. 3 illustrates a vertical cross-sectional view of the blower unit 16 according to the embodiment, seeing a housing 28 and its surrounding area.

FIG. 4 illustrates a perspective view of the blower unit 16 according to the embodiment, seeing a grip unit 38 and its surrounding area from a rear left upper side.

FIG. 5 illustrates a perspective view of the blower unit 16 according to the embodiment, seeing an internal structure of the grip unit 38 from a front right upper side.

FIG. 6 illustrates a lateral cross-sectional view of the grip unit 38 of the blower unit 16 according to the embodiment.

FIG. 7 illustrates a perspective view of an internal structure of the housing 28 in the blower unit 16 according to the embodiment as seen from a rear left lower side.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved working machines, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a working machine may comprise: a gripping member configured to be gripped by a user with one hand; a protection member that covers a surface of the gripping member at least partially and is constituted of a conductive material; an operation member configured to be operated by the user with the one hand; a detection sensor configured to detect an operation on the operation member; and a control unit. The protection member may include a contact portion received inside the gripping member. The detection sensor may include: a conductive component electrically connected to the control unit; and a sensor case that holds the conductive component and is constituted of an insulating material. The contact portion may be in contact with the sensor case.

In one or more embodiments, the working machine may be configured to be used in a state in which the working machine is held by the user and is apart from a ground.

In such working machine as described above, since electric charge caused by static electricity generated during use of the working machine does not move easily to the ground, the electric charge caused by static electricity is likely to be accumulated within the working machine. According to the above configuration, in the working machine in which static electricity tends to accumulate, the user's hand is not electrically connected to the control unit, and further, electric discharge caused by static electricity can be suppressed from taking place on the user's hand.

In one or more embodiments, the working machine may further comprise: an air flow passage; an air flow fan disposed in the air flow passage; and a prime mover configured to rotate the air flow fan. The control unit may be configured to control operation of the prime mover.

In such working machine as described above, electric charge in static electricity charged in microparticles in the air flowing in the working machine and/or electric charge caused by static electricity generated by the microparticles making contact with components in the working machine are likely to be accumulated within the working machine. According to the above configuration, in the working machine in which static electricity tends to accumulate, the user's hand is not electrically connected to the control unit, and further, electric discharge caused by static electricity can be suppressed from taking place on the user's hand.

In one or more embodiments, a wiring connecting the control unit and the detection sensor may extend 90 degrees or more in a circumferential direction along an outer surface of the air flow passage.

According to the above configuration, without use of a special member such as a conductive ring, the wiring connecting the control unit and the detection sensor can be utilized to collect electric charge of the static electricity generated in the air flow passage.

In one or more embodiments, a wiring connecting the control unit and a power source may extend 90 degrees or more in a circumferential direction along an outer surface of the air flow passage.

According to the above configuration, without use of a special member such as a conductive ring, the wiring connecting the control unit and the power source can be utilized to collect electric charge of the static electricity generated in the air flow passage.

In one or more embodiments, the prime mover may be an electric motor. The control unit may be configured to control operation of the electric motor by controlling electric power supplied to the electric motor.

In a working machine which uses an electric motor as the prime mover, because high-voltage power is supplied from the power source, it is necessary to ensure prevention of electrification on a user. According to the above configuration, because there is no electrical connection between the control unit and the user's hand, electrification on the user can be surely prevented, and also electric discharge caused by static electricity can be suppressed from taking place on the user's hand.

In one or more embodiments, a wiring connecting the control unit and the electric motor may extend 90 degrees or more in a circumferential direction along an outer surface of the air flow passage.

According to the above configuration, without use of a special member such as a conductive ring, the wiring connecting the control unit and the electric motor can be utilized to collect electric charge of the static electricity generated in the air flow passage.

In one or more embodiments, a working machine may comprise: a gripping member configured to be gripped by a user with one hand; a protection member that covers a surface of the gripping member at least partially and is constituted of a conductive material; an air flow passage; an air flow fan disposed in the air flow passage; an electric motor configured to rotate the air flow fan; and a wiring that is connected to the electric motor and extends 90 degrees or more in a circumferential direction along an outer surface of the air flow passage. Static electricity generated in the air flow passage may be collected by the wiring and transferred from the protection member to the one hand of the user.

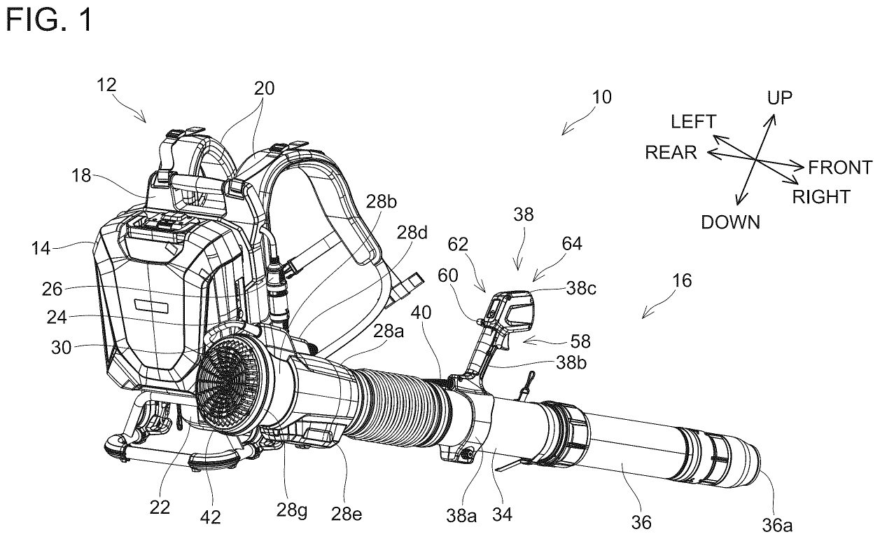

(Embodiment) As illustrated in FIG. 1, a blower 10 comprises a backpack unit 12, a battery unit 14, and a blower unit 16. The backpack unit 12 comprises a backpack frame 18, a pair of shoulder belts 20 attached to the backpack frame 18, and a waist belt 22 attached to the backpack frame 18. A user can hold the backpack unit 12 with the pair of shoulder belts 20 hung on his/her shoulders, the waist belt 22 wrapped around his/her waist, and the backpack unit 12 on his/her back.

The battery unit 14 is detachably attached to the backpack frame 18. The battery unit 14 houses a plurality of battery cells (not shown) therein. The battery unit 14 comprises a power button 24, a charging connector (not shown), and an electric discharge cable 26. The plurality of battery cells can be charged from an external power source (not shown) by being coupled to a charge cable (not shown) extending from the external power source. The power button 24 is configured to switch between on/off states of power of the battery unit 14. The plurality of battery cells is configured to discharge electricity via the electric discharge cable 26 when the power of the battery unit 14 is on.

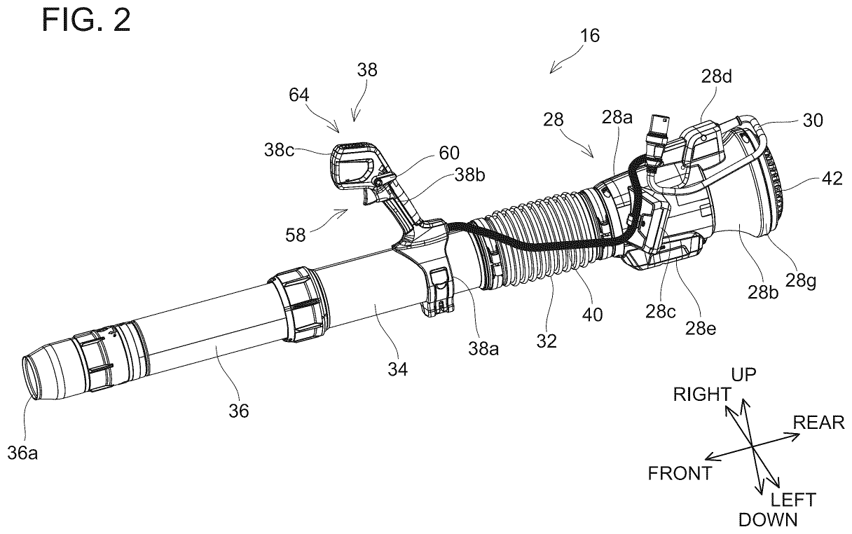

As shown in FIG. 2, the blower unit 16 comprises a housing 28 and a power cable 30. The housing 28 comprises a cylindrical portion 28a shaped in a substantially cylinder, a diameter-increasing portion 28b connected to one of ends of the cylindrical portion 28a in a central axis direction and having a shape with its diameter increasing as it separates away from the cylindrical portion 28a, a frame attachment portion 28c projecting outward from an outer surface of the cylindrical portion 28a, a cable holder portion 28d projecting outward from the outer surface of the cylindrical portion 28a and an outer surface of the diameter-increasing portion 28b, and a control unit accommodating portion 28e projecting outward from the outer surface of the cylindrical portion 28a. The housing 28 is configured to be attached to and detached from the backpack frame 18 (see FIG. 1) via the frame attachment portion 28c. The power cable 30 extends from the cable holder portion 28d and is connected to the electric discharge cable 26 (see FIG. 1). The blower unit 16 operates on power supplied via the electric discharge cable 26 and the power cable 30 from the battery unit 14 (see FIG. 1). Hereafter, a direction in which a central axis of the cylindrical portion 28a of the housing 28 will be denoted a front-rear direction, a direction of the diameter-increasing portion 28b as seen from the cylindrical portion 28a will be denoted rearward, and a direction opposite from rearward will be denoted frontward. Further, a direction perpendicular to the front-rear direction and also of the cable holder portion 28d as seen along the central axis of the cylindrical portion 28a will be denoted upward, and a direction opposite from upward will be denoted downward. A direction perpendicular to the front-rear and up-down directions will be denoted a left-right direction. The frame attachment portion 28c is disposed on the outer surface of a left side of the cylindrical portion 28a, and the cable holder portion 28d is disposed on the outer surface of upper sides of the cylindrical portion 28a and the diameter-increasing portion 28b, and the control unit accommodating portion 28e is disposed on the outer surface of a lower side of the cylindrical portion 28a. Further, the power cable 30 extends rearward from a rear surface of the cable holder portion 28d.

The blower unit 16 further comprises a bellows tube 32, a straight tube 34, a tip nozzle 36, a grip unit 38, and a signal cable 40. The bellows tube 32 is constituted of an insulating material (e.g., elastic resin). The straight tube 34 and the tip nozzle 36 are constituted of an insulating material (e.g., plastic). The bellows tube 32 connects a front part of the cylindrical portion 28a of the housing 28 and a rear part of the straight tube 34. The tip nozzle 36 is attached to a front part of the straight tube 34 and comprises an ejection port 36a at its tip. The grip unit 38 comprises an attaching portion 38a, a grip portion 38b, and a tip portion 38c. The attaching portion 38a is attached to the straight tube 34 so as to surround an outer circumference of the straight tube 34. The grip portion 38b extends front-and-upward from an upper part of the attaching portion 38a. The tip portion 38c extends frontward from an upper end of the grip portion 38b. The signal cable 40 extends frontward from a front surface of the cable holder portion 28d of the housing 28, and is connected with a rear surface of the upper part of the attaching portion 38a of the grip unit 38. The user can adjust a direction in which the ejection port 36a of the tip nozzle 36 is pointed by adjusting a posture of the straight tube 34 with the grip portion 38b being gripped.

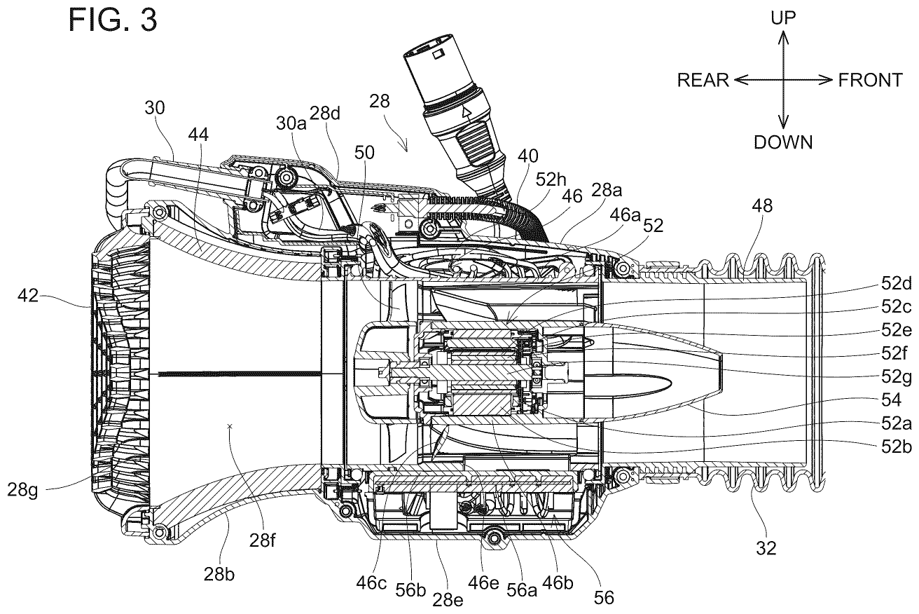

As shown in FIG. 3, the blower unit 16 further comprises an intake cover 42, a sound-proof member 44, a motor case 46, an air flow tube 48, an air flow fan 50, an electric motor 52, a diffusion cone 54, and a control unit 56. The intake cover 42, the motor case 46, the air flow tube 48, the air flow fan 50, and the diffusion cone 54 are constituted of insulating material(s) (e.g., plastic). The diameter-increasing portion 28b of the housing 28 has an intake passage portion 28f defined therein. The intake passage portion 28f has a shape with its diameter increasing from front to rear. The intake passage portion 28f comprises an intake port 28g at its rear end. The intake cover 42 is shaped in a grid having walls extending radially and circumferentially. The intake cover 42 is mounted so as to cover the intake port 28g of the housing 28. The sound-proof member 44 is affixed to an inner surface of the intake passage portion 28f.

The motor case 46 is housed inside the cylindrical portion 28a of the housing 28. The air flow tube 48 is held by the housing 28 such that the air flow tube 48 protrudes frontward from a front end of the cylindrical portion 28a on the front side of the motor case 46. The part of the air flow tube 48 protruding from the housing 28 has its periphery covered by the bellows tube 32.

The motor case 46 comprises an outer case 46a having a substantially cylindrical shape, an inner case 46b disposed inside the outer case 46a and having a substantially cylindrical shape, and stationary vanes 46c connecting the outer case 46a and the inner case 46b. A central axis of the outer case 46a and a central axis of the inner case 46b are both coaxial with a central axis of the cylindrical portion 28a. The inner case 46b has a smaller diameter than the outer case 46a and has a shorter length in the central axis direction than the outer case 46a. The diffusion cone 54 is attached to a front end of the inner case 46b, and is arranged to protrude frontward from a front end of the outer case 46a. A front part of the diffusion cone 54 is disposed inside the air flow tube 48.

The air flow fan 50 is disposed rearward of the inner case 46b inside the outer case 46a. The electric motor 52 is housed within the inner case 46b. In the present embodiment, the electric motor 52 is for example a brushless motor. The electric motor 52 comprises a stator 52b on which coils 52a are wound, a rotor 52d disposed inside the stator 52b and having a permanent magnet 52c, a sensor board 52f on which a Hall sensor 52e configured to detect magnetism of the permanent magnet 52c is mounted, and an output shaft 52g fixed to the rotor 52d and extending in the front-rear direction. The air flow fan 50 is fixed to a rear end of the output shaft 52g. Due to this, when the electric motor 52 is driven and thus the output shaft 52g rotates, the air flow fan 50 accordingly rotates.

When the air flow fan 50 rotates, air outside the blower unit 16 passes through the intake cover 42 and is suctioned into the intake port 28g. The air suctioned by the intake port 28g passes through the intake passage portion 28f, and flows into the motor case 46. Thereafter, the air passes through the air flow fan 50, flows in a space between the outer case 46a and the inner case 46b, and after the air is rectified by the stationary vanes 46c, it flows out of the motor case 46 and flows into the air flow tube 48. Thereafter, the air passes insides of the bellows tube 32 and the straight tube 34 shown in FIG. 2, and then is ejected from the ejection port 36a at the tip pf the tip nozzle 36.

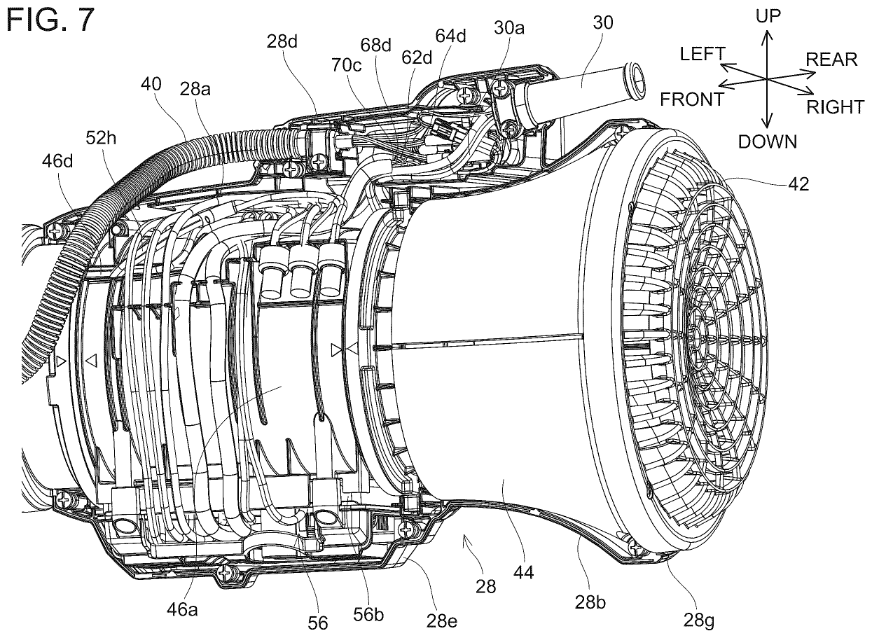

As shown in FIG. 3, the control unit 56 is housed within the control unit accommodating portion 28e of the housing 28. The control unit 56 comprises a control circuit board 56a and a circuit board case 56b housing the control circuit board 56a. The control circuit board 56a comprises a microcomputer (not shown) comprising a CPU, ROM, RAM, etc. and configured to control an entire operation of the blower unit 16 and an inverter circuit (not shown) configured to control an operation of the electric motor 52 by controlling power supplied to the electric motor 52. The control circuit board 56a and the electric motor 52 are electrically connected via a motor wiring 52h extending through a cabling space 46d (see FIG. 7) defined in one of the stationary vanes 46c. In the present embodiment, the motor wiring 52h comprises both wiring (not shown) connected to the coils 52a and wiring (not shown) connected to the sensor board 52f. Here, if the electric motor 52 is another type of motor that is not a brushless motor, such as a brush motor, and does not comprise the sensor board 52f, the motor wiring 52h only comprises the wiring (not shown) connected to the coils 52a. Also, the control circuit board 56a is electrically connected with power wiring 30a extending from inside of the power cable 30. A cooling opening 46e is defined at a lower part of the outer case 46a, and a portion of the circuit board case 56b is exposed to inside of the outer case 46a through the cooling opening 46e. Due to this, when the air flow fan 50 rotates, the air flowing in the space between the outer case 46a and the inner case 46b cools the control unit 56.

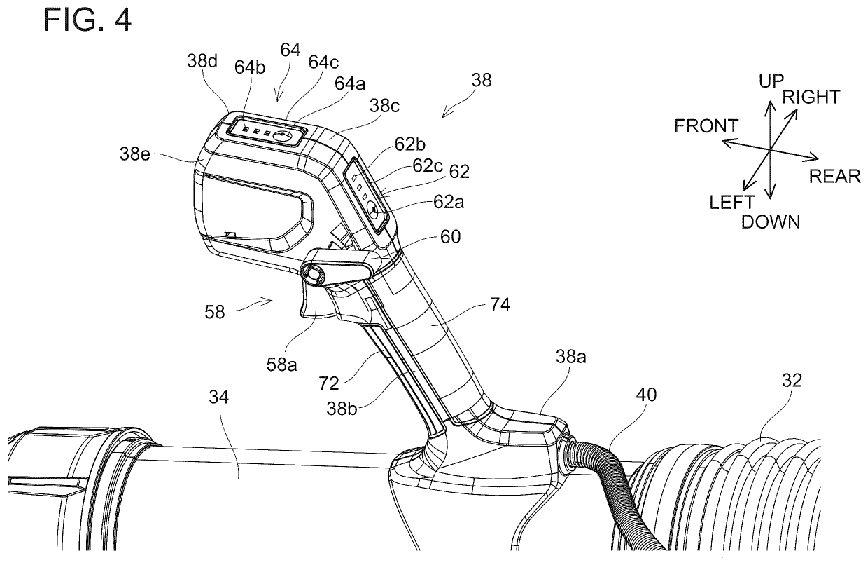

As shown in FIG. 4, the grip unit 38 comprises a right grip case 38d and a left grip case 38e. The right grip case 38d and the left grip case 38e are constituted of an insulating material (e.g., plastic). The right grip case 38d defines an outer shape of right halves of the attaching portion 38a, the grip portion 38b, and the tip portion 38c. The left grip case 38e defines an outer shape of left halves of the attaching portion 38a, the grip portion 38b, and the tip portion 38c.

The grip portion 38b comprises a trigger lever 58 positioned on a front surface of an upper part of the grip portion 38b, formed thereon. The tip portion 38c also comprises a control lever 60 positioned on a left surface of the tip portion 38c, a first indicator and operation panel 62 positioned on a rear surface of the tip portion 38c, and a second indicator and operation panel 64 positioned on an upper surface of the tip portion 38c. The first indicator and operation panel 62 comprises a power button 62a, a status indicator light 62b, a circuit board (not shown), and a panel case 62c. The power button 62a is configured to switch between on and off states of power of the blower unit 16. The status indicator light 62b is configured to inform a user of a status of on/off of the power of the blower unit 16. The panel case 62c is constituted of an insulating material (e.g., plastic) and houses the power button 62a, the status indicator light 62b, and the circuit board therein. The circuit board of the first indicator and operation panel 62 is electrically connected to the control circuit board 56a of the control unit 56 via the signal wiring 62d. The second indicator and operation panel 64 comprises a battery remaining level indicator button 64a, a battery remaining level indicator light 64b, a circuit board (not shown), and a panel case 64c. The battery remaining level indicator button 64a is configured to switch between on/off of the battery remaining level indicator light 64b. The battery remaining level indicator light 64b is configured to inform the user of a battery remaining level of the battery unit 14. The panel case 64c is constituted of an insulating material (e.g., plastic), and houses the battery remaining level indicator button 64a, the battery remaining level indicator light 64b, and the circuit board, therein. The circuit board of the second indicator and operation panel 64 is electrically connected to the control circuit board 56a of the control unit 56 via a signal wiring 64d. The signal wirings 62d, 64d extend through inside of the signal cable 40 from the grip unit 38 up to the housing 28.

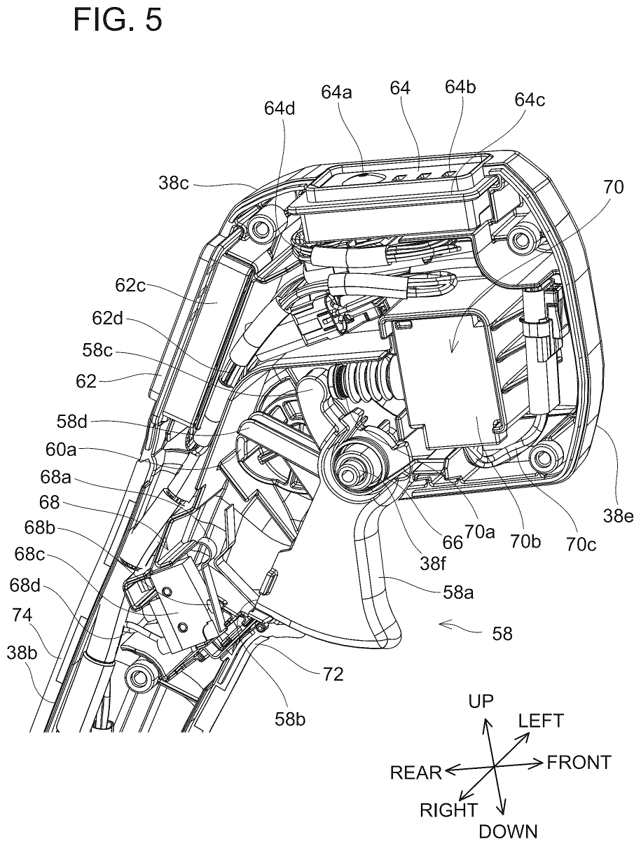

As shown in FIG. 5, the trigger lever 58 is rotatably supported by a boss 38f extending rightward from the left grip case 38e. The trigger lever 58 is constituted of an insulating material (e.g., plastic). The trigger lever 58 comprises an operation portion 58a, a first detecting portion 58b, a second detecting portion 58c, and an engaging portion 58d. The trigger lever 58 is biased by a torsion spring 66 in a pivoting direction along which the operation portion 58a moves frontward. The grip portion 38b has a first trigger switch 68 housed therein. The first trigger switch 68 comprises a switch lever 68a, a switch button 68b, and a switch case 68c. The first trigger switch 68 outputs an off signal when the switch lever 68a is separated away from the switch button 68b, and outputs an on signal when the switch lever 68a contacts the switch button 68b. The switch case 68c is constituted of an insulating material (e.g., plastic) and holds the switch lever 68a and the switch button 68b. The switch lever 68a and the switch button 68b are both conductive components, and are electrically connected to the control circuit board 56a of the control unit 56 via a signal wiring 68d. The tip portion 38c houses a second trigger switch 70 therein. The second trigger switch 70 comprises a switch button 70a and a switch case 70b. The second trigger switch 70 outputs a signal indicative of a degree at which the switch button 70a is pushed in. The switch case 70b is constituted of an insulating material (e.g., plastic), and holds the switch button 70a. The switch button 70a is a conductive component, and is electrically connected to the control circuit board 56a of the control unit 56 via a signal wiring 70c. The signal wirings 68d, 70c extend through inside of the signal cable 40 (see FIG. 4) from the grip unit 38 up to the housing 28.

The operation portion 58a is disposed outside the grip portion 38b, and receives a pushing operation by the user. The first detecting portion 58b is disposed to face the switch lever 68a of the first trigger switch 68, and the first detecting portion 58b is separated away from the switch lever 68a when the pushing degree of the operation portion 58a is less than a predefined degree, while the first detecting portion 58b contacts the switch lever 68a to allow the switch lever 68a to contact the switch button 68b when the pushing degree of the operation portion 58a is the predefined degree or more. The second detecting portion 58c is disposed to face the switch button 70a of the second trigger switch 70, and the second detecting portion 58c is separated away from the switch button 70a when the operation portion 58a is not pushed in while the second detecting portion 58c contacts the switch button 70a to push the switch button 70a in when the operation portion 58a is pushed in. Thus, the first trigger switch 68 is configured to detect whether the trigger lever 58 is pushed in or not, and the second trigger switch 70 is configured to detect the pushing degree of the trigger lever 58.

The engaging portion 58d is disposed to face an engaging piece 60a fixed to the control lever 60 (see FIG. 4). The control lever 60 accepts a pivoting operation from the user, and holds a pivoted angle operated by the user. When the control lever 60 pivots, the engaging portion 58d is pressed upward and thus the trigger lever 58 pivots similarly to when the operation portion 58a is pushed rearward. Since the pivoted angle of the control lever 60 is retained as-is even when the user lets his/her hand off the control lever 60, by pivoting the control lever 60, the trigger lever 58 can be held in a same state as when the operation portion 58a is pushed to a certain pushing degree.

As shown in FIG. 4, a front protection member 72 and a rear protection member 74 are attached to an outer surface of the grip portion 38b. The front protection member 72 and the rear protection member 74 are constituted of a conductive material, such as a conductive elastomer. The front protection member 72 covers a surface of a front part of the grip portion 38b, and the rear protection member 74 covers a surface of a rear part of the grip portion 38b. Although in the present embodiment, a portion of the surface of the grip portion 38b is exposed between the front protection member 72 and the rear protection member 74, an entirety of the surface of the grip portion 38b may be covered by the front protection member 72 and the rear protection member 74.

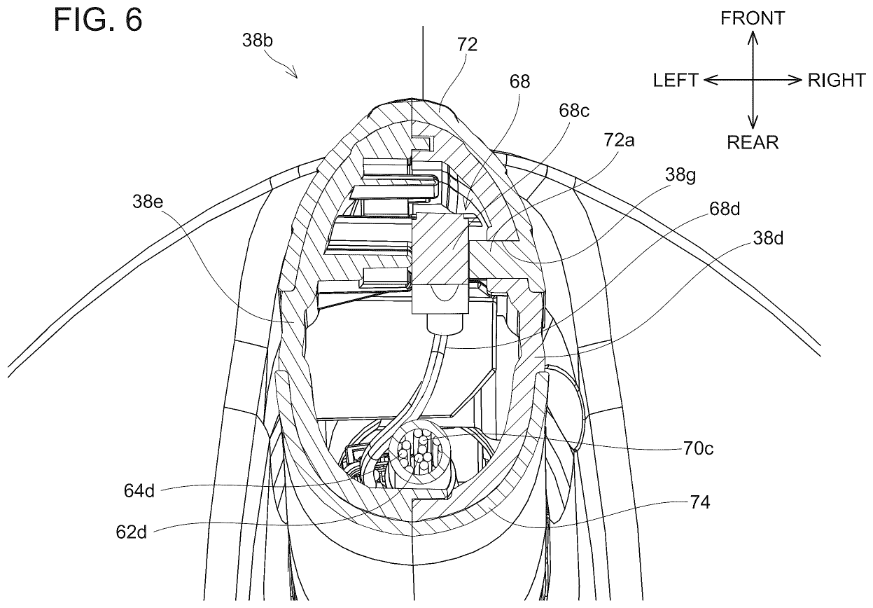

As illustrated in FIG. 6, the right grip case 38d of the grip portion 38b has a through hole 38g defined therein. The front protection member 72 comprises a contact portion 72a defined therein, the contact portion 72a penetrating the through hole 38g and received inside the grip portion 38b. A tip of the contact portion 72a is in contact with the switch case 68c of the first trigger switch 68.

As illustrated in FIG. 7, within the housing 28, the power wiring 30a extending from the power cable 30 extends along an outer surface of a left side of the outer case 46a from the cable holder portion 28d above the outer case 46a to the control unit 56 below the outer case 46a. Also, within the housing 28, the signal wirings 62d, 64d, 68d, 70c extending from the signal cable 40 extend along the outer surface of the left side of the outer case 46a from the cable holder portion 28d above the outer case 46a to the control unit 56 below the outer case 46a. Further, within the housing 28, the motor wiring 52h extending from the electric motor 52 firstly extends along the outer surface of the left side of the outer case 46a from the cabling space 46d of the stationary vanes 46c to an upper part of the outer case 46a, and further extends along the outer surface of the left side of the outer case 46a to a lower part of the outer case 46a to be connected to the control unit 56.

When the blower 10 sends air, electric charge caused by static electricity charged in microparticles in the air flowing inside the blower 10 and/or electric charges caused by static electricity generated by the microparticles making contact with components in the blower 10 accumulate in the motor case 46. This electric charge caused by static electricity is collected by the power wiring 30a, the signal wirings 62d, 64d, 68d, and 70c, and the motor wiring 52h extending along the outer surface of the outer case 46a. This electric charge caused by static electricity causes electric potentials of the first indicator and operation panel 62, the second indicator and operation panel 64, the first trigger switch 68, and the second trigger switch 70 of the grip unit 38 connected to the signal wirings 62d, 64d, 68d, and 70c to rise. In the present embodiment, the contact portion 72a of the front protection member 72 which is in contact with a user's hand is in contact with the switch case 68c of the first trigger switch 68. Due to this, electric discharge from the switch lever 68a and/or the switch button 68b of the first trigger switch 68 to the contact portion 72a of the front protection member 72 takes place, and the electric charge caused by static electricity is transferred to the user's hand from the front protection member 72. The electric discharge at this occasion does not take place on a surface of the user's hand, but takes place inside the grip unit 38, as a result of which the user does not suffer discomfort and the static electricity accumulated in the blower 10 can be discharged outside.

Here, in order to collect the electric charge accumulated in the motor case 46, any one of the power wiring 30a, the signal wirings 62d, 64d, 68d, and 70c, and the motor wiring 52h needs to extend 90 degrees or more in the circumferential direction along the outer case of the outer case 46a. The power wiring 30a, the signal wirings 62d, 64d, 68d, and 70c and/or the motor wiring 52h may for example extend in a range of 90 degrees or more, may for example extend in a range of 120 degrees or more, and may for example extend in a range of 180 degrees or more. The more the range in which the power wiring 30a, the signal wirings 62d, 64d, 68d, and 70c and/or the motor wiring 52h extends, the more surely electric charge accumulated in the motor case 46 can be collected.

(Modifications) In the above embodiment, a configuration in which the working machine is the blower 10 is described. Unlike this, the working machine may be a cleaner, a dust collector, or a vacuum blower, for example.

In the above embodiment, a configuration in which the blower 10 is a backpack-type blower is described. In another embodiment, the blower 10 may be another type of blower instead of the backpack-type. For example, the blower 10 may be a hand-held blower.

In the above embodiment, a configuration in which the power of the blower 10 is the battery unit 14 and power is supplied from the battery unit 14 to the blower unit 16 is described. Unlike this, the power of the blower 10 may be an external power source (not shown) which the user does not wear on his/her body and power may be supplied from the external power source to the blower unit 16. Alternatively, the power of the blower 10 may be a battery pack (not shown) configured to be attached to/detached from the blower unit 16, and power may be supplied from the battery pack to the blower unit 16.

In the above embodiment, a configuration in which the prime mover of the blower 10 is the electric motor 52 and input from the electric motor 52 allows the air flow fan 50 to rotate is described. Unlike this, the prime mover of the blower 10 may be an internal combustion engine (not shown) and the input from the engine may allow the air flow fan 50 to rotate.

In the above embodiment, the electric motor 52 is a brushless motor. Unlike this, the electric motor 52 may be a brush motor or may be another type of motor.

In the above embodiment, a configuration in which the contact portion 72a of the front protection member 72 is in contact with the switch case 68c of the first trigger switch 68 is described. Unlike this, the contact portion 72a of the front protection member 72 may be in contact with the switch case 70b of the second trigger switch 70, may be in contact with the panel case 62c of the first indicator and operation panel 62, and/or may be in contact with the panel case 64c of the second indicator and operation panel 64. Also, instead of the contact portion 72a of the front protection member 72, the rear protection member 74 may comprise a contact portion (not shown).

(Correspondence) The blower 10 (example for working machine) comprises: the grip unit 38 (example for a gripping member) configured to be gripped by a user with one hand; the front protection member 72 (example for a protection member) that covers the surface of the grip unit 38 at least partially and is constituted of the conductive elastomer (example for a conductive material); the trigger lever 58 (example for an operation member) configured to be operated by the user with the one hand; the first trigger switch 68 (example for a detection sensor) configured to detect an operation on the trigger lever 58; and the control unit 56. The front protection member 72 includes the contact portion 72a received inside the grip unit 38, the first trigger switch 68 includes: the switch lever 68a, the switch button 68b (examples for a conductive component) electrically connected to the control unit 56; and the switch case 68c (example for a sensor case) that holds the switch lever 68a and the switch button 68b and is constituted of plastic (example for an insulating material). The contact portion 72a is in contact with the switch case 68c.

According to the above configuration, because the front protection member 72 is constituted of the conductive elastomer and the contact portion 72a of the front protection member 72 is in contact with the switch case 68c, when static electricity is accumulated in the blower 10, electric discharge happens between the switch lever 68a, the switch button 68b of the first trigger switch 68 and the contact portion 72a of the front protection member 72, and electric charge is transferred from the front protection member 72 to a user's hand. Due to this, the user's hand is not electrically connected to the control unit 56, and further, electric discharge caused by static electricity can be suppressed from taking place on the user's hand. According to the above configuration, since the contact portion 72a is in contact with the switch case 68c, variation in a distance between the contact portion 72a and the switch lever 68a, the switch button 68b can be reduced, and stable discharge property can be realized between the contact portion 72a and the switch lever 68a, the switch button 68b.

In one or more embodiments, the blower 10 is configured to be used in a state in which the blower 10 is held by the user and is apart from a ground.

In such blower 10 as described above, since electric charge caused by static electricity generated during use of the blower 10 does not move easily to the ground, the electric charge caused by static electricity is likely to be accumulated within the blower 10. According to the above configuration, in the blower 10 in which static electricity tends to accumulate, the user's hand is not electrically connected to the control unit 56, and further, electric discharge caused by static electricity can be suppressed from taking place on the user's hand.

In one or more embodiments, the blower 10 further comprises the motor case 46 (example for an air flow passage); the air flow fan 50 disposed in the motor case 46; and the electric motor 52 (example for a prime mover) configured to rotate the air flow fan 50. The control unit 56 is configured to control operation of the electric motor 52.

In the blower 10 as described above, electric charge in static electricity charged in microparticles in the air flowing in the blower 10 and/or electric charge caused by static electricity generated by the microparticles making contact with components in the blower 10 are likely to be accumulated within the blower 10. According to the above configuration, in the blower 10 in which static electricity tends to accumulate, the user's hand is not electrically connected to the control unit, and further, electric discharge caused by static electricity can be suppressed from taking place on the user's hand.

In one or more embodiments, the signal wiring 68d (example for a wiring) connecting the control unit 56 and the first trigger switch 68 extends 90 degrees or more in a circumferential direction along the outer surface of the motor case 46.

According to the above configuration, without use of a special member such as a conductive ring, the signal wiring 68d connecting the control unit 56 and the first trigger switch 68 can be utilized to collect electric charge of the static electricity generated in the motor case 46.

In one or more embodiments, the power wiring 30a (example for a wiring) connecting the control unit 56 and the battery unit 14 (example for a power source) extends 90 degrees or more in the circumferential direction along the outer surface of the motor case 46.

According to the above configuration, without use of a special member such as a conductive ring, the power wiring 30a connecting the control unit 56 and the battery unit 14 can be utilized to collect electric charge of the static electricity generated in the motor case 46.

In one or more embodiments, the control unit 56 is configured to control operation of the electric motor 52 by controlling electric power supplied to the electric motor 52.

In the blower 10 which uses the electric motor 52 as the prime mover, because high-voltage power is supplied from the battery unit 14, it is necessary to ensure prevention of electrification on a user. According to the above configuration, because there is no electrical connection between the control unit 56 and the user's hand, electrification on the user can be surely prevented, and also electric discharge caused by static electricity can be suppressed from taking place on the user's hand.

In one or more embodiments, the motor wiring 52h (example for a wiring) connecting the control unit 56 and the electric motor 52 extends 90 degrees or more in the circumferential direction along the outer surface of the motor case 46.

According to the above configuration, without use of a special member such as a conductive ring, the motor wiring 52h connecting the control unit 56 and the electric motor 52 can be utilized to collect electric charge of the static electricity generated in the motor case 46.

In one or more embodiments, the blower 10 (example for working machine) comprises: the grip unit 38 (example for a gripping member) configured to be gripped by a user with one hand; the front protection member 72 (example for a protection member) that covers the surface of the grip unit 38 at least partially and is constituted of conductive elastomer (example for a conductive material); the motor case 46 (example for an air flow passage); the air flow fan 50 disposed in the motor case 46; the electric motor 52 configured to rotate the air flow fan 50; and the motor wiring 52h (example for a wiring) that is connected to the electric motor 52 and extends 90 degrees or more in the circumferential direction along the outer surface of the motor case 46. Static electricity generated in the motor case 46 is collected by the motor wiring 52h and transferred from the front protection member 72 to the one hand of the user.

According to the above configuration, without use of a special member such as a conductive ring, the motor wiring 52h connected to the electric motor 52 can be utilized to collect electric charge of static electricity generated in the motor case 46.

What is claimed is:

1. A working machine, comprising:
a gripping member configured to be gripped by a user with one hand;
a protection member that covers a surface of the gripping member at least partially and is constituted of a conductive material;
an operation member configured to be operated by the user with the one hand;
a detection sensor configured to detect an operation on the operation member; and
a control unit,
wherein the protection member includes a contact portion received inside the gripping member,
the detection sensor includes:
a conductive component electrically connected to the control unit; and
a sensor case that holds the conductive component and is constituted of an insulating material, and
the contact portion is in contact with the sensor case.

2. The working machine according to claim 1, wherein the working machine is configured to be used in a state in which the working machine is held by the user and apart from a ground.

3. The working machine according to claim 1, further comprising:
an air flow passage;
an air flow fan disposed in the air flow passage; and
a prime mover configured to rotate the air flow fan,
wherein the control unit is configured to control operation of the prime mover.

4. The working machine according to claim 3, wherein a wiring connecting the control unit and the detection sensor extends 90 degrees or more in a circumferential direction along an outer surface of the air flow passage.

5. The working machine according to claim 3, wherein a wiring connecting the control unit and a power source extends 90 degrees or more in a circumferential direction along an outer surface of the air flow passage.

6. The working machine according to claim 3, wherein the prime mover is an electric motor, and
the control unit is configured to control operation of the electric motor by controlling electric power supplied to the electric motor.

7. The working machine according to claim 6, wherein a wiring connecting the control unit and the electric motor extends 90 degrees or more in a circumferential direction along an outer surface of the air flow passage.

8. A working machine, comprising:
a gripping member configured to be gripped by a user with one hand;
a protection member that covers a surface of the gripping member at least partially and is constituted of a conductive material;
an air flow passage;
an air flow fan disposed in the air flow passage;
an electric motor configured to rotate the air flow fan; and
a wiring that is connected to the electric motor and extends 90 degrees or more in a circumferential direction along an outer surface of the air flow passage,
wherein static electricity generated in the air flow passage is collected by the wiring and transferred from the protection member to the one hand of the user.

9. The working machine according to claim 2, further comprising:
an air flow passage;
an air flow fan disposed in the air flow passage; and
a prime mover configured to rotate the air flow fan,
wherein the control unit is configured to control operation of the prime mover,
a wiring connecting the control unit and the detection sensor extends 90 degrees or more in a circumferential direction along an outer surface of the air flow passage,
a wiring connecting the control unit and a power source extends 90 degrees or more in the circumferential direction along the outer surface of the air flow passage,
the prime mover is an electric motor,
the control unit is configured to control operation of the electric motor by controlling electric power supplied to the electric motor,
a wiring connecting the control unit and the electric motor extends 90 degrees or more in the circumferential direction along the outer surface of the air flow passage, and
static electricity generated in the air flow passage is collected by the wiring connecting the control unit and the detection sensor, the wiring connecting the control unit and the power source, and/or the wiring connecting the control unit and the electric motor, and transferred from the protection member to the one hand of the user.
